(19) United States
(12) Patent Application Publication
(10) Pub. No.: US 2025/0137888 A1
(43) Pub. Date: May 1, 2025

(54) EQUIPMENT-INSPECTION NAVIGATION DEVICE WITH POSITION LOCKING AND DROP PROTECTION, AND METHODS OF USING THE SAME

(71) Applicant: Swabbot Solutions, LLC., Raleigh, NC (US)

(72) Inventors: Richard Anthony MINEO, Raleigh, NC (US); Donovan WALLACE, Ottawa (CA); Matt BAILEY, Ottawa (CA); Kevin WESTERMANN, Kanata (CA); Steve AUGER, Stittsville (CA)

(21) Appl. No.: 18/926,041

(22) Filed: Oct. 24, 2024

Related U.S. Application Data
(60) Provisional application No. 63/546,314, filed on Oct. 30, 2023.

(51) Int. Cl. G01N 1/02; G01N 1/28

(52) U.S. Cl. CPC G01N 1/02; G01N 1/286; G01N 2001/028

(57) ABSTRACT

The disclosed technology greatly improves the safety, accuracy, and efficiency of cleaning validation processes. Swabbing can be performed in a fully automated fashion. The cost and safety risk of confined-space entry is avoided. An equipment-inspection navigation device is disclosed, comprising an equipment mount base configured to attach to an equipment access port; an extension-pole control device connected to the equipment mount base; modular extension poles connected to the extension-pole control device; a test tool connected to the modular extension poles; a test-tool position-compensation sub-system connected to the modular extension poles; and a surface-contact-sensing sub-system connected to the test-tool position-compensation sub-system. The present invention solves a variety of problems heretofore encountered during swabbing processes, and is effective even for challenging surfaces, such as agitator shafts. Use cases include surface swabbing for cleaning validation and equipment monitoring; cleaning validation bacteria contact plate sampling; and measurement of surface thickness and surface roughness.

### PRIORITY DATA

This patent application is a non-provisional application claiming priority to U.S. Provisional Patent App. No. 63/546,314, filed on Oct. 30, 2023, which is hereby incorporated by reference herein.

### FIELD OF THE INVENTION

The present invention generally relates to automated swabbing, cleaning validation, and internal inspection of equipment in biotechnology, pharmaceutical, medical-device, and related industries.

### BACKGROUND OF THE INVENTION

In life sciences, food, cosmetics, and other related industries, ensuring that the equipment used in the production of customer products is appropriately maintained and clean is a critical issue concerning consumer and employee safety. Due to the size and complexity of some manufacturing equipment, performing the required testing for cleanliness and maintenance can require an employee to be in an unsafe situation and/or negatively impact their ability to perform the testing properly. The following tests are routinely performed on manufacturing equipment: (1) cleaning validation surface swabbing, (2) cleaning validation bacterial contact plate testing, (3) environmental monitoring surface swabbing, (4) environmental monitoring bacterial contact plate testing, (5) pressure vessel wall thickness testing, and (6) surface roughness testing.

Cleaning validation and environmental monitoring are critical quality assurance and control programs utilized by companies in the life sciences, food, and cosmetic industries. Regulatory agencies, such as the FDA or EMA, mandate that companies that produce and sell consumer products must execute scientifically developed cleaning validation and environmental monitoring programs to be licensed to sell their products. When performed correctly, these programs give the company a high degree of assurance that their products are not cross-contaminated by other products they manufacture or other foreign materials. Cleaning validation and environmental monitoring programs consist of (1) predefined test methods and protocols, (2) training and certification, and (3) test equipment and consumables.

Companies in the life sciences, food, and cosmetic industries develop maintenance programs to ensure that equipment performs as expected over its usable life. These maintenance programs include test methods designed to measure specific variables that can indicate a pending problem with the equipment. Regulatory agencies such as the Occupational Health and Safety Administration (OHSA) require some tests, such as pressure vessel wall thickness testing, to be performed routinely to ensure employee safety. A company's cleaning validation program may require routine surface roughness or rouging testing since changes to the product-contact surfaces can adversely affect the performance of the cleaning process.

A significant problem that companies encounter when they perform the tests required by their cleaning validation, environmental monitoring, and maintenance programs is human error and testing variability. Human error is any deviation from predefined testing methods caused by an individual performing the test method. Testing variability is inherent test-method variability, such as the accuracy and precision of the test devices utilized in the test method. Testing performed in hard-to-reach or difficult-to-access locations will have increased variability and a high chance of inaccurate results because the individuals performing the testing are not in an adequate position, making the testing difficult to perform. Companies spend considerable time and money training and certifying individuals to perform these tests. Even with much training, there is still a high risk of false-pass or false-fail results, which are both problematic.

In some cases, testing must be performed in a confined space, which is dangerous, costly, and time-consuming. To minimize the risk of injury or death, companies develop a stringent confined-space entry program that clearly defines the safety procedures, required protective equipment, and monitoring devices needed during the confined-space entry. Each confined-space entry requires (1) a pre-approved work permit signed by multiple stakeholders; (2) preparation of the confined space before entry; (3) specialized equipment for entry, monitoring, and recovery; and (4) multiple support personnel in place during the test execution. Even when safety procedures and additional safety measures are in place, there have unfortunately been many deaths or injuries during confined-space entry.

One solution that companies are using to remove the risk of confined-space entry is to perform cleaning validation surface swabbing using a telescoping pole. This solution eliminates the risk of confined-space entry for that test type, but it dramatically reduces the recovery and increases test variability. Consequently, there is a higher risk of false-positive or false-negative results, which increases costs and puts the company and users of its products at risk. If swabbing is performed using a telescoping pole as opposed to vessel entry, then the risk of not adequately performing the sampling increases due to the distance between the person controlling the swab and the swab location, using prior-art methods and systems.

Given the problems outlined above with the current state of the art, there is a strong commercial desire for improved consistency, accuracy, recovery, cost, and safety for cleaning validation, environmental monitoring, and maintenance testing of equipment used to manufacture consumer products in the life sciences, food, cosmetics, and related industries.

### SUMMARY OF THE INVENTION

Some variations of the invention provide an equipment-inspection navigation device comprising:
an equipment mount base configured to attach to an access port of a selected inspectable equipment;
an extension-pole control device connected to the equipment mount base;
one or more modular extension poles connected to the extension-pole control device;
a test tool connected to at least one of the modular extension poles;
a test-tool position-compensation sub-system connected to the modular extension poles; and
a surface-contact-sensing sub-system connected to the test-tool position-compensation sub-system.

In some embodiments, the equipment mount base is configured to rotate around the access port of the selected inspectable equipment.

In some embodiments, the extension-pole control device provides three degrees of freedom to move the test tool within the selected inspectable equipment.

In some embodiments, the extension-pole control device comprises auto-locking independent crank handles.

In some embodiments, the modular extension poles utilize interlocking barbs.

In some embodiments, the test-tool position-compensation sub-system provides two degrees of freedom for the test tool relative to the modular extension poles.

In some embodiments, the surface-contact-sensing sub-system comprises a sensor that provides feedback on initial contact of the test tool with an interior surface of the selected inspectable equipment.

In some embodiments, the surface-contact-sensing sub-system comprises a sensor that provides feedback on distance of the test tool from an interior surface of the selected inspectable equipment.

In typical embodiments of the equipment-inspection navigation device, the test tool contains a swab.

In some embodiments, the test tool is configured to measure or detect bacteria.

In some embodiments, the test tool is configured to measure surface thickness and/or surface roughness.

In some embodiments, the test tool is configured to record photographic data comprising photographic images and/or video. The photographic data may be utilized to map multiple interior surfaces of the selected inspectable equipment, for example.

In certain embodiments, the test tool contains a swab configured to contact interior surfaces of the selected inspectable equipment, wherein the test tool is configured to utilize the photographic data, as an input, to assist in directing placement of the swab, as an output.

In some embodiments, a control sub-system is configured to drive electric motors to move the test tool to a desired location.

In some embodiments, the equipment-inspection navigation device is configured with six degrees of freedom.

In some embodiments, the equipment-inspection navigation device is automated.

Other variations of the invention provide an equipment-inspection navigation device comprising:
an extension pole configured for insertion into an inspectable equipment, the extension pole having a first end portion and a second end portion;
a pole-mounting system coupled to the first end portion of the extension pole, wherein the pole-mounting system is configured to attach to an accessible region of the inspectable equipment that is accessible from a space outside the inspectable equipment; and
an automated swab device coupled to the second end portion of the extension pole, wherein the automated swab device is configured to execute a swabbing process on an interior surface of the inspectable equipment,
wherein the automated swab device is connected to the extension pole via a locking joint and a spring unit,
wherein the locking joint is adjustable and configured to allow for a plurality of different angular orientations of the automated swab device in relation to the extension pole, and
wherein the spring unit is flexible and configured to allow for a plurality of different positions of the automated swab device in relation to the interior surface of the inspectable equipment.

In some embodiments, the pole-mounting system includes a mount base and an extension-pole control device coupled to the mount base, wherein the pole-mounting system is configured to attach to the accessible region via the mount base, and wherein the pole-mounting system is coupled to the first end portion of the extension pole via the extension-pole control device.

Still other variations of the invention provide an equipment-inspection navigation device comprising:
a pole-mounting system configured to attach to an accessible region of the inspectable equipment that is accessible from a space outside the inspectable equipment;
an extension pole configured for insertion into the inspectable equipment, wherein the extension pole includes a plurality of pole segments; and
a set of barbs connected to the extension pole,
wherein the plurality of pole segments are detachably coupled to one another via the set of barbs, wherein each barb within the set of barbs is configured with an independent lock mechanism, and
wherein the pole-mounting system includes an extension-pole control device detachably coupled to at least one pole segment from the plurality of pole segments.

In some embodiments, at least one pole segment from the plurality of pole segments is extendable from a first segment length to a second segment length, wherein the set of barbs are configured to prevent the plurality of pole segments from extending beyond a stop length associated with the extension pole.

Yet other variations of the invention provide a method of inspecting equipment, the method comprising:
(a) selecting an inspectable equipment to be inspected;
(b) providing an equipment-inspection navigation device, wherein the equipment-inspection navigation device comprises an equipment mount base configured to attach to an access port of a selected inspectable equipment; an extension-pole control device connected to the equipment mount base; one or more modular extension poles connected to the extension-pole control device; a test tool connected to at least one of the modular extension poles; a test-tool position-compensation sub-system connected to the modular extension poles; and a surface-contact-sensing sub-system connected to the test-tool position-compensation sub-system;
(c) attaching the equipment mount base to the access port of the inspectable equipment;
(d) navigating the test tool to a desired interior surface of the inspectable equipment using the extension-pole control device and the modular extension poles;
(e) positioning the test tool against a desired interior surface using the test-tool position-compensation sub-system and the surface-contact-sensing sub-system; and
(f) performing an inspection using the test tool, wherein the inspection is optionally selected from the group consisting of surface swabbing for cleaning validation, surface swabbing for equipment monitoring, bacteria contact plate sampling for cleaning validation, bacteria contact plate sampling for equipment monitoring, surface-thickness measurement, surface-roughness measurement, and combinations thereof, and
wherein optionally steps (d), (e), and (f) are automated.

### BRIEF DESCRIPTION OF THE DRAWINGS

FIG. 1 depicts a system comprising an inspectable equipment (illustrated as a tank) and an equipment-inspection navigation device, in some embodiments of the invention.

FIG. 2 depicts a system comprising an inspectable equipment (illustrated as a tank, with diagram focus on the tank manway) and an equipment-inspection navigation device, in some embodiments of the invention.

FIG. 3A is a detailed schematic diagram of an equipment mount base including equipment base extension arms, equipment base far-side clamp supports, a main load-bearing rotation bushing, and an equipment base clamp, in some embodiments of the invention.

FIG. 3B is another detailed schematic diagram of the equipment mount base shown in FIG. 3A, including equipment base extension arms, equipment base far-side clamp supports, extension-pole control device quick-release rails, and slots for angle adjustment, in some embodiments of the invention.

FIG. 4A is a detailed schematic diagram of an extension-pole control device including dual pole feed collapsible handles, a pole-feed brake mechanism, a pitch control handle, a quick-release lock handle, quick-release slide tabs, and a pressure-adjustment spring axle, in some embodiments of the invention.

FIG. 4B is another detailed schematic diagram of the extension-pole control device shown in FIG. 4A, including a pole feed collapsible handle, a pitch control handle, a drive roller, passive rollers, a pitch control leadscrew housing, and a pitch control linkage, in some embodiments of the invention.

FIG. 5A is a schematic diagram of an extension-pole control device locking independent handle, including a moving handle, a lockable handle, and a ratchet pawl, in some embodiments of the invention.

FIG. 5B another schematic diagram of the extension-pole control device locking independent handle shown in FIG. 5A, with dual pole feed collapsible handles allowing for convenient operation from either side, in some embodiments of the invention.

FIG. 6 is a schematic diagram of an interlocking system for modular extension poles, in different positions of an extension pole, in some embodiments of the invention.

FIG. 7A is a schematic diagram of a system for extension-pole control device passthrough protection, in some embodiments of the invention.

FIG. 7B is another schematic diagram of the system in FIG. 7A for extension-pole control device passthrough protection, in some embodiments of the invention.

FIG. 7C is another schematic diagram of the system in FIG. 7A for extension-pole control device passthrough protection, in some embodiments of the invention.

FIG. 8A is a schematic diagram of a test-tool position-compensation sub-system, including a mount, a sewn cover, a spring, and a button, in some embodiments of the invention.

FIG. 8B is a schematic diagram of a system comprising a test tool and a button that allows the joint to rotatably move ±90°, in some embodiments of the invention.

FIG. 9A is a schematic diagram of a surface-contact-sensing sub-system including a replaceable, high-friction non-marking plunger tip for gripping the tank walls, and a spring providing the plunger extension force, in some embodiments of the invention.

FIG. 9B is another schematic diagram of the surface-contact-sensing sub-system shown in FIG. 9A, in some embodiments of the invention in the plunger tip contacts the tank walls in various patterns or geometries, such as perpendicular, positive, and negative surface contact planes.

FIG. 10A is a schematic diagram of a surface-contact-sensing sub-system in which there are three points of contact, which is desirable for confirming surface detection and swabbing distance which translates into swabbing pressure, in some embodiments of the invention.

FIG. 10B depicts the surface contact seating geometry achieved with the surface-contact-sensing sub-system of FIG. 10A.

FIG. 11A is a schematic diagram of a surface-contact-sensing sub-system in which horizontal and vertical centering bosses are utilized, in some embodiments of the invention.

FIG. 11B is another schematic diagram of the surface-contact-sensing sub-system shown in FIG. 11A, including large centering bosses, in some embodiments of the invention.

FIG. 12A depicts the inspection of a shaft coupling that couples sections of an agitator shaft, using a test tool, in some embodiments of the invention.

FIG. 12B depicts the inspection of an agitator shaft using a test tool in a vertical configuration, in some embodiments of the invention.

FIG. 12C depicts the inspection of an agitator shaft using a test tool in a horizontal configuration, in some embodiments of the invention.

FIG. 12D depicts the inspection of a shaft coupling using a test tool in a vertical configuration, in some embodiments of the invention.

FIG. 12E depicts the inspection of a shaft coupling using a test tool in a vertical configuration, in some embodiments of the invention.

FIG. 13 is a schematic diagram of a surface-contact-sensing sub-system, in which a cylinder is being inspected/tested, in some embodiments of the invention.

FIG. 14 is a schematic diagram of a test tool sub-system with a protective flexible cover and swab protector, wherein a test tool is configured with a stretchable membrane, a swab protector, and a membrane holder, in some embodiments of the invention.

### DETAILED DESCRIPTION OF EMBODIMENTS OF THE INVENTION

The systems (equivalently, apparatus) and methods of the present invention will be described in detail by reference to various non-limiting embodiments.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms, except when used in Markush groups. Thus in some embodiments not otherwise explicitly recited, any instance of “comprising” may be replaced by “consisting of” or, alternatively, by “consisting essentially of.”

In this specification, reference will be made in certain embodiments to a Swabbot™, an automated swabbing device (test tool) that executes a swabbing process. Swabbot is a trademark owned by Swabbot Solutions, LLC, which is the same assignee as the assignee of the present patent application. The present invention is by no means limited to the Swabbot device.

In this specification, “equipment” is a singular noun and is synonymous with “vessel,” “tank,” and “reactor”. In this specification, a “vessel” is synonymous with “tank” when no reaction is taking place and is synonymous with “reactor” when a reaction is taking place within the vessel. An “equipment wall” (or “vessel wall”) refers to an internal surface, such as an inner wall or other internal component within the equipment boundary. A vessel wall may be an inner wall, an agitator surface, an agitator shaft surface, a shaft-coupling surface, a sensor surface, a vessel window, a top surface, a bottom surface, a surface of an internal component (e.g., temperature sensor or dissolved-oxygen probe), or any other surface that can be inspected.

The present invention allows users to navigate, position, and hold a testing device at a desired location within a selected inspectable equipment so that the specified test method can be performed appropriately to determine the acceptability of the equipment being tested. The present invention, in various embodiments, solves a variety of problems heretofore encountered during swabbing processes.

The disclosed test devices and methods include, but are not limited, to surface swabbing for cleaning validation and equipment monitoring; cleaning validation bacteria contact plate sampling for cleaning validation and equipment monitoring; surface thickness measurement; and surface roughness measurement. These tests are done routinely and designed to ensure selected equipment remains within its design specifications. For example, automatic or manual surface swabbing for cleaning validation is used as a direct test verification method for surface cleanliness. The amount of residual product from the last manufacturing process and other potential contaminants remaining on the equipment's product-contact surfaces must be below the scientifically developed acceptable levels before sequential products may be manufactured in that equipment. A swab sample of the surface after the equipment has been cleaned will determine if the surface has been cleaned to the specified acceptable level, thus reducing the risk of subsequent product contamination, which could lead to product loss, product recalls, or injury or death to individuals using the product.

Some variations of the invention provide an equipment-inspection navigation device comprising:
an equipment mount base configured to attach to an access port of a selected inspectable equipment;
an extension-pole control device connected to the equipment mount base;
one or more modular extension poles connected to the extension-pole control device;
a test tool connected to at least one of the modular extension poles;
a test-tool position-compensation sub-system connected to the modular extension poles; and
a surface-contact-sensing sub-system connected to the test-tool position-compensation sub-system.

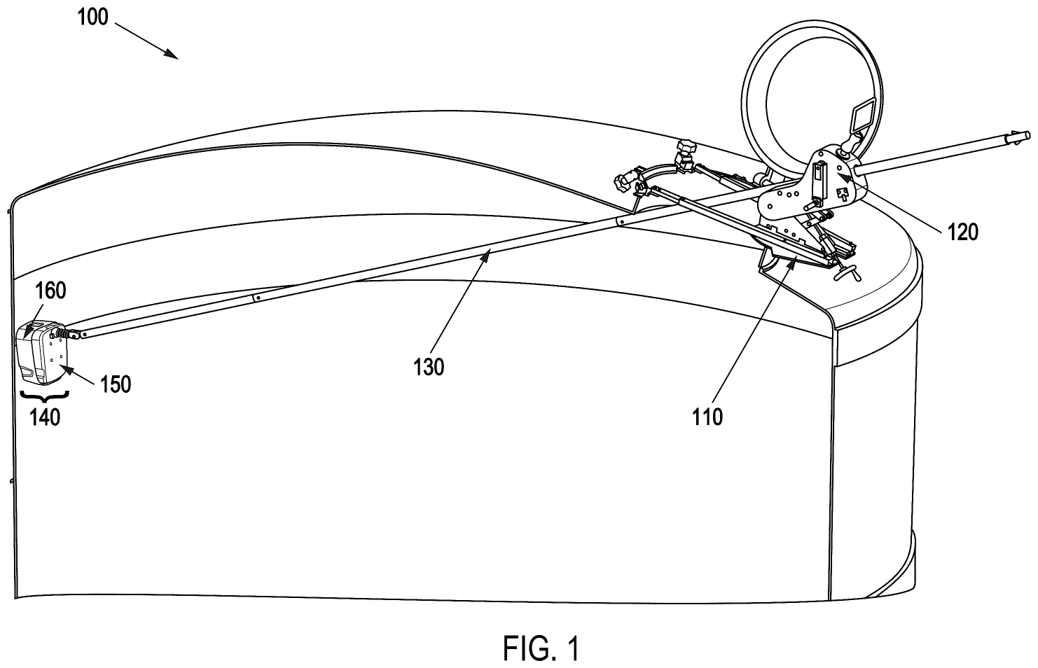

The primary functional components of the equipment-inspection navigation device are the equipment mount base, the extension-pole control device, the modular extension poles, the test tool, the test-tool position-compensation sub-system, and the surface-contact-sensing sub-system. Each of the primary functional components assist in the navigation and positioning of the test tool, and/or mitigate the risk of damage to the test tool due to component failures or operator errors. FIG. 1, discussed in more detail later, depicts the primary functional components of the equipment-inspection navigation device.

The equipment-inspection navigation device is preferably configured with safety features to ensure that parts of the device do not fall into the equipment.

In certain embodiments, the equipment-inspection navigation device is configured with six degrees of freedom, which provides significant advantages for both precision and accuracy in testing.

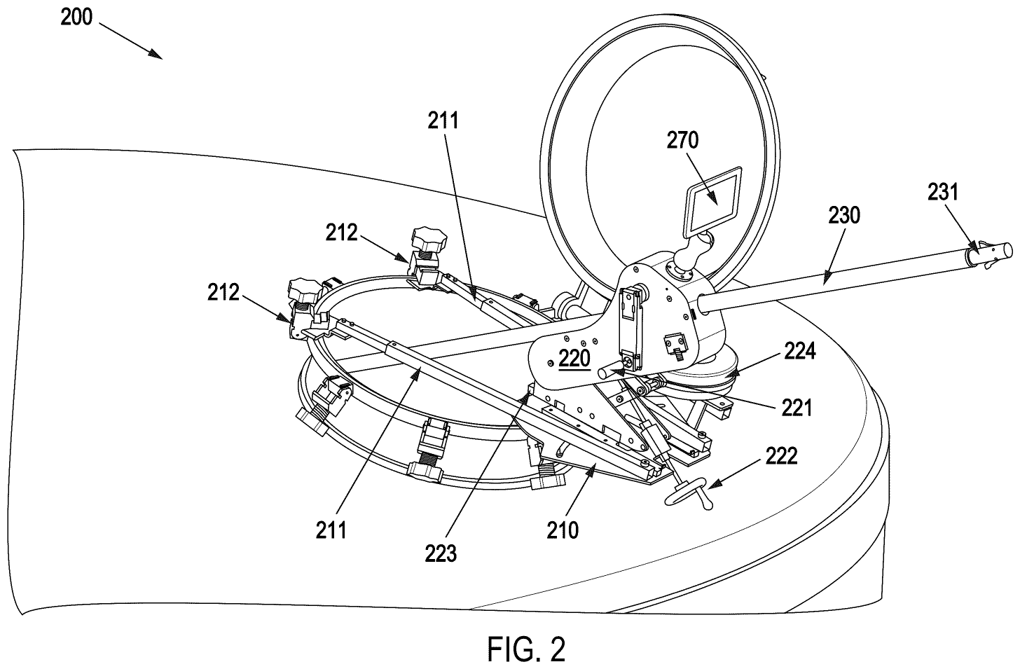

The equipment mount base provides a stable platform for the extension-pole control device, the modular extension poles, the test-tool position-compensation sub-system, the surface-contact-sensing sub-system, and the test tool itself. The equipment mount base securely attaches directly to the equipment or other structures close to the equipment access port. The equipment mount base allows the equipment-inspection navigation device to rotate around the access port, giving the system one degree of freedom to access different areas within the equipment. FIG. 2, discussed in more detail later, depicts the equipment mount base attached directly to a vessel with an extension-pole control device and modular extension poles attached.

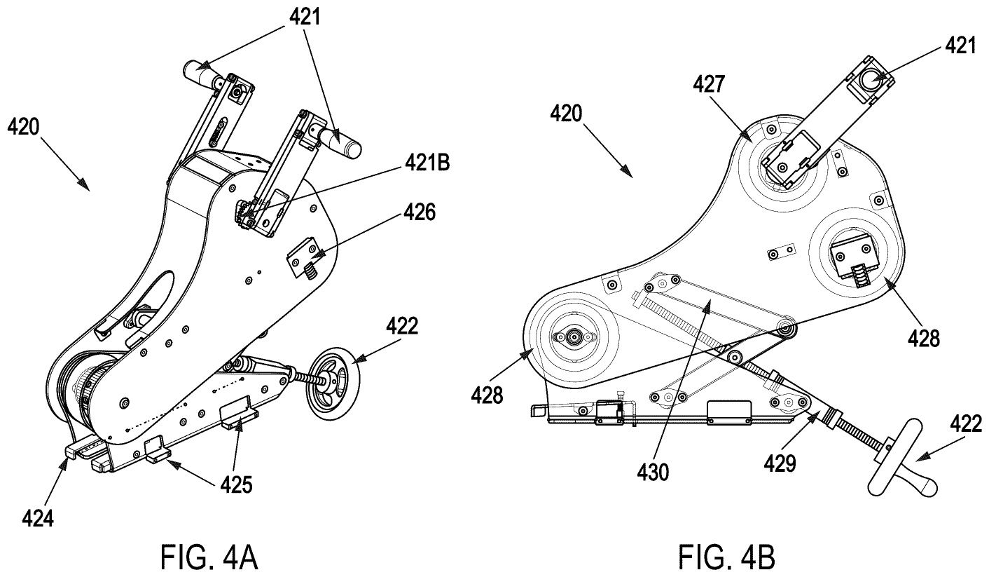

In some embodiments, the equipment mount base is configured to rotate around the access port of the selected inspectable equipment. The equipment mount base preferably has adjustable attachment points to connect the equipment-inspection navigation device to different-sized access ports and tie-down types. Parts of the equipment mount base that come in contact with the equipment are preferably covered with material that does not mark or leave any residuals on the equipment surface. The equipment mount base is preferably equipped with a quick-connect device that allows the extension-pole control device to be easily connected and disconnected from the equipment mount base (see FIG. 4A, discussed in detail below).

Different equipment mount bases may be configured to mount the equipment-inspection navigation device directly to various types of equipment or structures near the equipment access port, depending on the application. The modular design of the equipment-inspection navigation device allows for custom or equipment-specific equipment mount bases to be interchangeably used with the equipment-inspection navigation device and different testing tools.

In this specification, an “extension-pole control device” is a structural and functional device that allows for adjusting both (a) the angle of the modular extension poles with respect to the tank opening, as well as (b) the extension of the modular extension poles into or out of the tank. Although the extension-pole control device is connected to the equipment base mount, the extension-pole control device is preferably a physically separate device from the equipment base mount due to weight, rather than a single device containing the equipment base mount and the extension-pole control device.

In some embodiments, the extension-pole control device provides three degrees of freedom to move the test tool within the selected inspectable equipment. The use of three degrees of freedom for the test tool leads to higher precision as well as accuracy for the desired testing. The extension-pole control device may be designed to perform one or more of the following functions: (1) change the angle of the modular extension poles with respect to the equipment; (2) increase or decrease the length of the modular extension poles within the equipment; (3) allow for the rotation of the modular extension poles to properly align the test tool with respect to the surface being tested; (4) apply the necessary force to the modular extension poles to hold the test tool in place during the execution of the test procedure; and (5) provide drop protection to ensure that the modular extension poles and the test tool do not fall into the equipment, thereby damaging the test tool and/or the equipment.

In some embodiments, the extension-pole control device has an anti-drop feature. For example, the extension-pole control device may comprise auto-locking independent crank handles, designed to stop the movement of the modular extension poles in case the operator loses control of the handle. The equipment mount base may include connection points and a safety tether that can be secured to a structure on the outside of the equipment to protect against equipment damage if the equipment mount base is inadvertently dropped or if the mounting points fail during operation. To improve usability and mitigate operator error, the crank handles operate independently via a gearing system in the pole drive roller. This feature is critical to the safe operation of the extension-pole control device, since the device orientation can limit the operator's ability to feed the modular extension poles effectively.

The number of individual, modular extension poles that make up the total extension pole (“extended pole system”) may vary, such as 1, 2, 3, 4, 5, or more. The number of modular extension poles utilized will generally be dictated by the equipment geometry, e.g. the distance to be traversed from the equipment access port to the wall, as well as the length of each modular extension pole. Different lengths of modular extension poles may be used, such as from a kit containing various lengths as desired for the given application. In a certain embodiment (e.g., a small tank), a single extension pole is used.

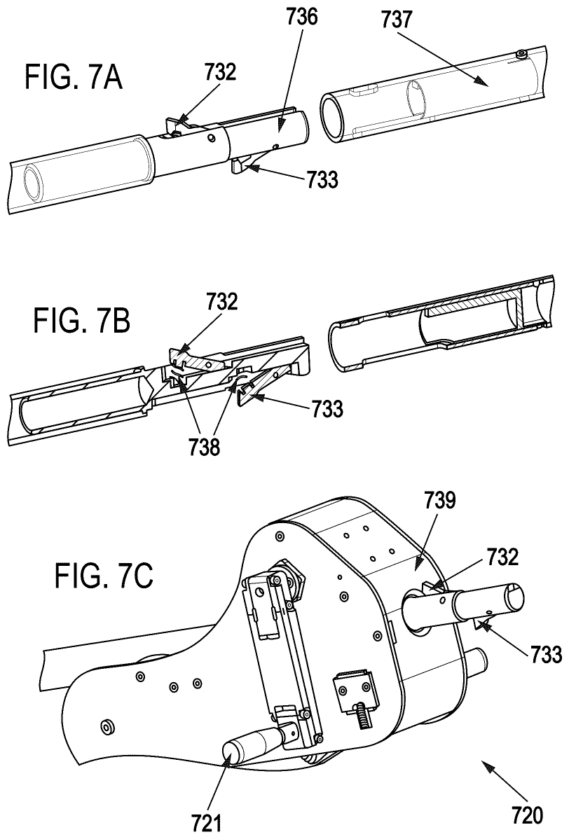

In some embodiments, the modular extension poles utilize interlocking barbs. The modular extension poles allow the equipment-inspection navigation device to extend its reach within the selected equipment without limiting its use cases due to limited space around the equipment being tested. Since many modular poles are typically used to reach far locations within the equipment, the modular extension poles are designed to interlock together to form an extended pole system quickly. The use of many poles creates the following risks to the test tool and equipment: (1) poles may come disconnected due to improper assembly; (2) poles may come disconnected due to locking mechanism failure; and (3) poles may lose connection with the drive wheel due to the operator continuing to extend the pole into the equipment past the end of the pole or a failure of the drive wheel and locking handles. In the present invention, the modular extension poles are designed to mitigate these risks with a redundant interlocking barb system (see FIGS. 7A and 7B). These barbs act as independent locks to ensure the poles remain connected, to provide a visual indication that the poles are connected adequately during assembly, and to provide a limit stop to prevent the poles from passing through the extension-pole control device (see FIG. 7C).

In some embodiments, the test-tool position-compensation sub-system provides two degrees of freedom for the test tool relative to the modular extension poles. This relative freedom is beneficial to allow the test tool to sit against the surface being tested properly. Without the test-tool position-compensation sub-system, the test tool motion may be restricted, limiting the locations within the equipment that can be tested. The test-tool position-compensation sub-system may include a tethered spring unit and an adjustable locking joint. The adjustable locking joint allows the operator to orient the test tool before inserting it into the equipment. This angle is determined by the operator based on the target location. The tethered spring unit is flexible and allows fine movement in the test tool orientation, enabling compensation when holding the test tool against the surface, and providing drop protection caused by the device's failure.

In some embodiments, the surface-contact-sensing sub-system comprises a sensor that provides feedback on initial contact of the test tool with an interior surface of the selected inspectable equipment. In some embodiments, the surface-contact-sensing sub-system comprises a sensor that provides feedback on distance of the test tool from an interior surface of the selected inspectable equipment. The surface-contact-sensing sub-system may provide the desired feedback to the operator for adequately placing the test tool against the tested surface. In some embodiments, the surface-contact-sensing sub-system includes multiple sensors that provide the operator with both types of feedback: (1) when initial contact is made with the surface; and (2) when the test tool is at the proper distance from the surface.

Sensors allows the equipment-inspection navigation device to be effectively navigated to the surface using no-marking contact pads. These no-marking contact pads and the sensor's mechanical arms provide force against the test tool which is needed to seat the test tool against the surface properly. In some embodiments, the test tool is configured with a sensor that accurately determines the distance from the test tool to the equipment's surface. In some embodiments, the test tool is configured with a sensor designed to ensure that the testing tool is positioned properly with respect to the equipment's surface. This ensures that the test will be performed with high accuracy and precision.

In typical embodiments of the equipment-inspection navigation device, the test tool contains a swab. The use of a swab in testing may utilize technology disclosed in U.S. Pat. No. 10,576,511, issued on Mar. 3, 2020 to Mineo, which is hereby incorporated by reference.

In some embodiments, the test tool is configured to measure or detect bacteria. The test tool may be configured to measure or detect a wide variety of materials beyond bacteria, including living organisms (e.g., bacteria or yeast), viruses, enzymes, proteins, antibiotics, or chemical contaminants (e.g., corrosion byproducts), for example. The test tool may be configured to measure or detect the chemical composition at an internal vessel wall, which chemical composition may be indicative of a material layer disposed on the wall, or may be indicative of the health of the wall material itself (e.g., presence or absence of corrosion, erosion, pitting, cracking, porosity, microdefects, or leaks). These potential measurements of chemical composition at the surface are types of equipment testing, as intended herein.

In some embodiments, the test tool is configured to measure surface thickness and/or surface roughness. Surface thickness and surface roughness can be important parameters for the integrity and safety of equipment. Reduction of surface thickness over time can be indicative of loss of wall material, which may occur if the wall material is not inert with respect to the equipment contents. Increase of surface roughness can also be indicative of loss of wall material, such as via corrosion or reaction of the wall material itself, or the deposition of other materials onto the surface. High surface roughness can be problematic for many reasons, such as making it easier for bacteria to survive a sterilization procedure.

In some embodiments, the test tool is configured to record photographic data comprising photographic images and/or video. The photographic data may be utilized to map multiple interior surfaces of the selected inspectable equipment, for example.

In certain embodiments, the test tool contains a swab configured to contact interior surfaces of the selected inspectable equipment, wherein the test tool is configured to utilize the photographic data, as an input, to assist in directing placement of the swab, as an output.

In some embodiments, the equipment-inspection navigation device is utilized to provide a stable base to allow for a test tool (e.g., an automated swabbing device such as a Swabbot, a camera, or another measurement device) to be maneuvered inside a vessel or equipment.

In some embodiments, the equipment-inspection navigation device is utilized to apply force to a test tool (e.g., an automated swabbing device such as a Swabbot, a camera, or another measurement device) used for equipment inspection to ensure that the test tool is correctly positioned and that position is maintained for the duration of the test.

In some embodiments, after the testing has been performed, the equipment-inspection navigation device is utilized to navigate a test tool (e.g., an automated swabbing device such as a Swabbot, a camera, or another measurement device) from the equipment back to the external environment.

In some embodiments, the equipment-inspection navigation device is equipped with a laser and/or camera to guide the test tool (e.g., an automated swabbing device such as a Swabbot, a camera, or another measurement device) into position.

In some embodiments, a control sub-system is configured to drive electric motors to move the test tool to a desired location. Control sub-systems are well-known in the art and generally are performed by a computing device. The control sub-system may be connected to the Internet and may be remote-controlled. In this way, the equipment-inspection navigation device may be fully automated, if desired.

Other variations of the invention provide an equipment-inspection navigation device comprising:
an extension pole configured for insertion into an inspectable equipment, the extension pole having a first end portion and a second end portion;
a pole-mounting system coupled to the first end portion of the extension pole, wherein the pole-mounting system is configured to attach to an accessible region of the inspectable equipment that is accessible from a space outside the inspectable equipment; and
an automated swab device coupled to the second end portion of the extension pole, wherein the automated swab device is configured to execute a swabbing process on an interior surface of the inspectable equipment,
wherein the automated swab device is connected to the extension pole via a locking joint and a spring unit,
wherein the locking joint is adjustable and configured to allow for a plurality of different angular orientations of the automated swab device in relation to the extension pole, and
wherein the spring unit is flexible and configured to allow for a plurality of different positions of the automated swab device in relation to the interior surface of the inspectable equipment.

In some embodiments, the pole-mounting system includes a mount base and an extension-pole control device coupled to the mount base, wherein the pole-mounting system is configured to attach to the accessible region via the mount base, and wherein the pole-mounting system is coupled to the first end portion of the extension pole via the extension-pole control device.

Still other variations of the invention provide an equipment-inspection navigation device comprising:
a pole-mounting system configured to attach to an accessible region of the inspectable equipment that is accessible from a space outside the inspectable equipment;
an extension pole configured for insertion into the inspectable equipment, wherein the extension pole includes a plurality of pole segments; and
a set of barbs connected to the extension pole,
wherein the plurality of pole segments are detachably coupled to one another via the set of barbs, wherein each barb within the set of barbs is configured with an independent lock mechanism, and
wherein the pole-mounting system includes an extension-pole control device detachably coupled to at least one pole segment from the plurality of pole segments.

In some embodiments, at least one pole segment from the plurality of pole segments is extendable from a first segment length to a second segment length, wherein the set of barbs are configured to prevent the plurality of pole segments from extending beyond a stop length associated with the extension pole.

Yet other variations of the invention provide a method of inspecting equipment, the method comprising:
(a) selecting an inspectable equipment to be inspected;
(b) providing an equipment-inspection navigation device, wherein the equipment-inspection navigation device comprises an equipment mount base configured to attach to an access port of a selected inspectable equipment; an extension-pole control device connected to the equipment mount base; one or more modular extension poles connected to the extension-pole control device; a test tool connected to at least one of the modular extension poles; a test-tool position-compensation sub-system connected to the modular extension poles; and a surface-contact-sensing sub-system connected to the test-tool position-compensation sub-system;
(c) attaching the equipment mount base to the access port of the inspectable equipment;
(d) navigating the test tool to a desired interior surface of the inspectable equipment using the extension-pole control device and the modular extension poles;
(e) positioning the test tool against a desired interior surface using the test-tool position-compensation sub-system and the surface-contact-sensing sub-system; and
(f) performing an inspection using the test tool,
wherein the inspection is optionally selected from the group consisting of surface swabbing for cleaning validation, surface swabbing for equipment monitoring, bacteria contact plate sampling for cleaning validation, bacteria contact plate sampling for equipment monitoring, surface-thickness measurement, surface-roughness measurement, and combinations thereof, and
wherein optionally steps (d), (e), and (f) are automated.

In preferred methods, steps (d), (e), and (f) are automated via a computing device. The computing device may be programmed with executable code to send electronic signals to a control system that drives electric motors used to move the testing tool to and from the desired location(s). The computing device may be programmed with executable code to control a vision system (e.g., a visible-light camera or one or more lasers) to map at least a portion of the interior surface of the vessel. The computing device may be programmed with executable code to run a software application that collects and analyzes the test data. The computing device may be programmed with executable code to automatically load consumables used by the equipment-inspection navigation device (e.g., swabs).

In methods utilizing bacteria contact plate sampling for cleaning validation and/or equipment monitoring, the bacterial growth may be manual or automated. In certain embodiments, the test tool gathers a sample of bacteria that is genetically sequenced, as an additional step. In the future, if DNA sequence analyzers become sufficiently miniaturized, the test tool may directly include a small DNA sequence analyzer.

Some method variations are intended for non-contact inspection of equipment inner walls. In these methods, visual inspection (such as with a camera) or laser inspection may be performed with the test tool, which does not necessarily make contact with the equipment wall since no sample is necessarily being collected.

Still other variations provide a method of inspecting equipment, the method comprising:
(a) selecting an inspectable equipment to be inspected;
(b) providing an equipment-inspection navigation device, wherein the equipment-inspection navigation device comprises an equipment mount base configured to attach to an access port of a selected inspectable equipment; an extension-pole control device connected to the equipment mount base; one or more modular extension poles connected to the extension-pole control device; and a test tool connected to at least one of the modular extension poles, wherein the test tool is configured to make at least one non-contact measurement with a wall of the inspectable equipment;
(c) attaching the equipment mount base to the access port of the inspectable equipment;
(d) navigating the test tool to a desired interior surface of the inspectable equipment using the extension-pole control device and the modular extension poles; and
(e) performing an inspection using the test tool,
wherein the inspection is optionally selected from the group consisting of optical photography imaging, optical video imaging, laser-based imaging, X-ray imaging, ultrasound imaging, and combinations thereof, and
wherein optionally steps (d) and (e) are automated.

In methods of non-contact testing, the test tool may be configured with one means of inspection, or multiple means of inspection. The test tool may be configured with an optical camera for taking photographs, video, or both of these. The test tool may be configured with a laser source of various laser frequencies, for making a laser-based assessment of the wall, such as to measure surface roughness or surface thickness. For example, laser scanning (profilometry) is an effective inspection method for measuring changes in an equipment wall. Laser-scanning data is used to measure the deviations from normal geometry, such as those caused by corrosion or mechanical damage. Various laser frequencies may be utilized. In some embodiments, the test tool is configured for generating X-rays that can analyze the equipment wall. X-ray data may be used in various ways, such as X-ray diffraction or X-ray computed tomography, for example. In some embodiments, the test tool is configured for generating high-frequency ultrasonic waves through a transducer to the equipment wall being tested. The reflected wave can be analyzed to identify the potential defects in the wall structure. With sufficient miniaturization, the test tool may be equipped with optical microscopy, scanning electron microscopy, or other types of imaging that utilize the scattering of photons, electrons, or neutrons.

Various embodiments of the technology will now be further discussed in reference to the accompanying drawings, which will be understood as exemplary and non-limiting.

FIG. 1 depicts a system 100 comprising an inspectable equipment (illustrated as a tank) and an equipment-inspection navigation device. The equipment-inspection navigation device includes an equipment mount base 110, an extension-pole control device 120, modular extension poles 130, and a test tool 140. The test tool 140 includes a test-tool position-compensation sub-system 150 and a surface-contact-sensing sub-system 160 connected to the test-tool position-compensation sub-system 150.

FIG. 2 depicts a system 200 comprising an inspectable equipment (illustrated as a tank, with diagram focus on the tank manway) and an equipment-inspection navigation device. The equipment-inspection navigation device includes an equipment mount base 210, an extension-pole control device 220, modular extension poles 230, equipment base adjustable arms 211, equipment base interlocks 212, an extension control handle 221, an angle (pitch) control handle 222, an extension-pole control device release 223, a communication and power feed reel 224, an extension pole interlock 231, and a test tool digital interface 270.

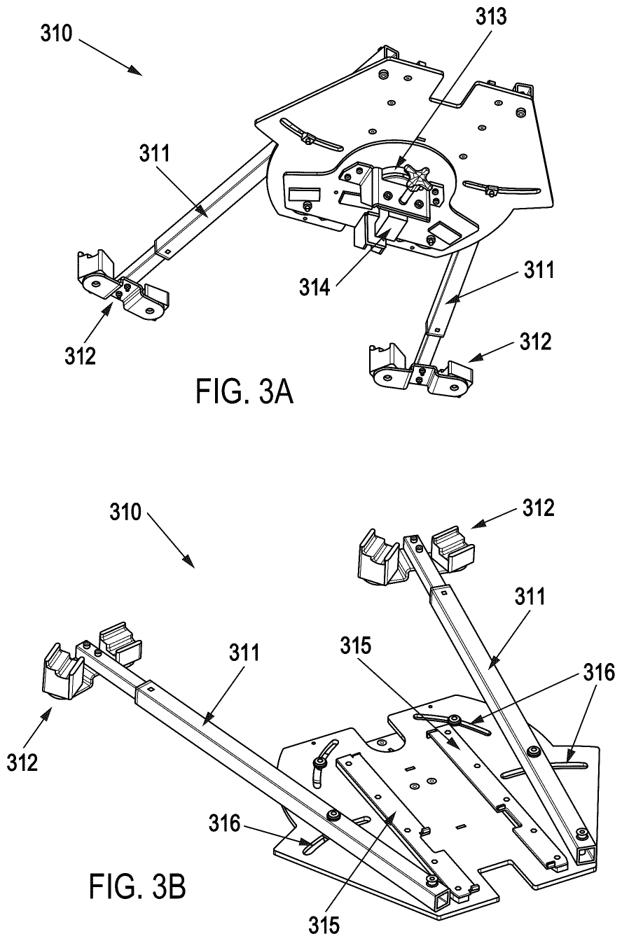

FIG. 3A is a detailed schematic diagram of an equipment mount base 310. The equipment mount base 310 includes equipment base extension arms 311, equipment base far-side clamp supports 312, a main load-bearing rotation bushing 313, and an equipment base clamp 314. The equipment base extension arms 311 allow for spanning multiple sizes of manways with minimal size of the navigation device, and avoids the need for multiple covers to inspect different tanks. The equipment base far-side clamp supports 312 are clamped by standard clamps used to secure the manway cover when the tank is in operation. Variations in top surface design and height address a wide range of manway clamp varieties. The main load-bearing rotation bushing 313 allows for a variety of access angles into the tank from a single setup of three hard clamps to the manway surface. The equipment base clamp 314 clamps to the near side of a tank manway.

FIG. 3B is another detailed schematic diagram of the equipment mount base 310 shown in FIG. 3A. The equipment mount base 310 includes equipment base extension arms 311, equipment base far-side clamp supports 312, extension-pole control device quick-release rails 315, and slots for angle adjustment 316. The slots for angle adjustment 316, along with the main load-bearing rotation bushing 313 (shown in FIG. 3A), allow for a variety of access angles into the tank from a single setup of the three hard clamps to the manway surface.

FIG. 4A is a detailed schematic diagram of an extension-pole control device 420. The extension-pole control device 420 includes dual pole feed collapsible handles 421, a pole-feed brake mechanism 421B, a pitch control handle 422, a quick-release lock handle 424, quick-release slide tabs 425, and a pressure-adjustment spring axle 426. The dual pole feed collapsible handles 421 allow for simple operation from either side of the tank, which is advantageous because tank access can be challenging when there are variations in the environments around tank openings. The pole-feed brake mechanism 421B automatically stops the pole feed if a user is not pulling the handle out to release the ratchet. Rotation of the pitch control handle 422 allows for increasing and decreasing the pitch angle of the extension pole when it is in place between the rollers. The quick-release lock handle 424 allows for sliding forward of the entire extension-pole control device 420 by pressing down on the quick-release lock handle 424, to remove the extension-pole control device 420 from the equipment mount base.

FIG. 4B is another detailed schematic diagram of the extension-pole control device 420 shown in FIG. 4A. The extension-pole control device 420 includes a pole feed collapsible handle 421, a pitch control handle 422, a drive roller 427, passive rollers 428, a pitch control leadscrew housing 429, and a pitch control linkage 430. The drive roller 427 is configured with an integrated 2:1 differential for lower-force operation by a user. The passive rollers 428 provide pressure into the drive roller 427 to allow for appropriate friction on the extension pole. The pitch control leadscrew housing 429 holds the lead nut for final gear reduction. The pitch control linkage 430 allows for input force reduction and angular travel range required for up to approximately 90% tank surface access.

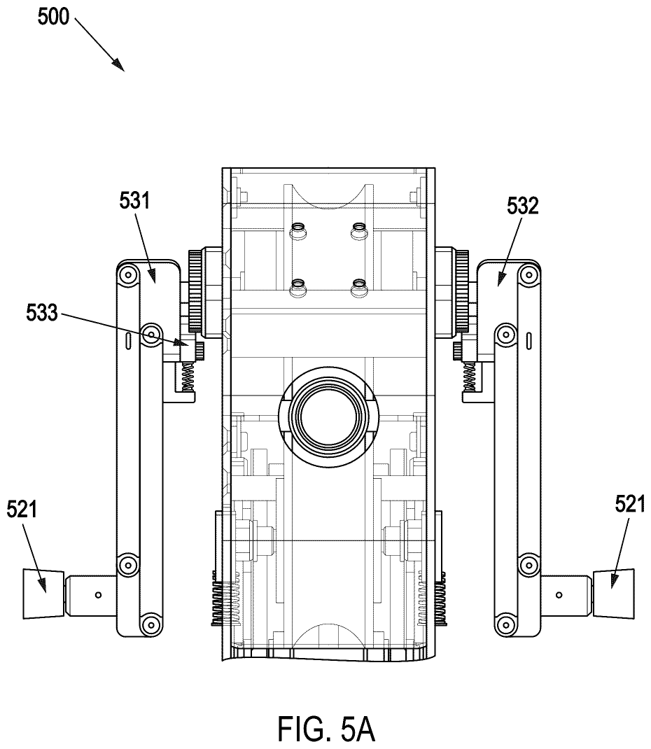

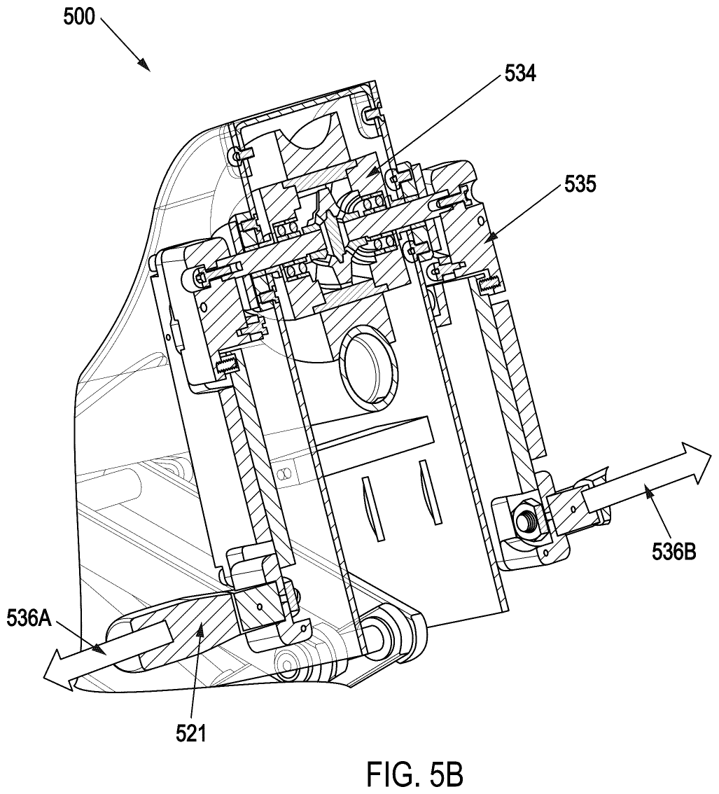

FIG. 5A is a schematic diagram 500 of an extension-pole control device locking independent handle. There is a moving handle 531, a lockable handle 532, and a ratchet pawl 533. Dual pole feed collapsible handles 521 allow for convenient operation from either side. Differential gearing inside the drive roller (shown in FIG. 4B) enables handle operation on either side—one hand active while the other is locked. A 2:1 differential gearing provides mechanical advantage for a user feeding the extension pole through the extension-pole control device.

FIG. 5B another schematic diagram 500 of the extension-pole control device locking independent handle shown in FIG. 5A. Dual pole feed collapsible handles 521 allow for convenient operation from either side. A drive roller internal differential 534 is utilized. A four-bar spring-loaded handle linkage 535 requires user input and one hand to be on the handle for the brake to be released, ensuring the pole cannot move if the user is not in control of the drive roller wheel with one or both of the handles. To release the lock on the roller, one handle or the other (arrow 536A or arrow 536B), or both handles (arrows 536A and 536B), need to be pulled outward by the user. Then the handles are free to rotate. In this configuration, if a user pulls out both handles (one hand per side) they will lose the advantage of the 2:1 gear ratio on the force application to the pole given by the differential, but the pole will move twice as fast.

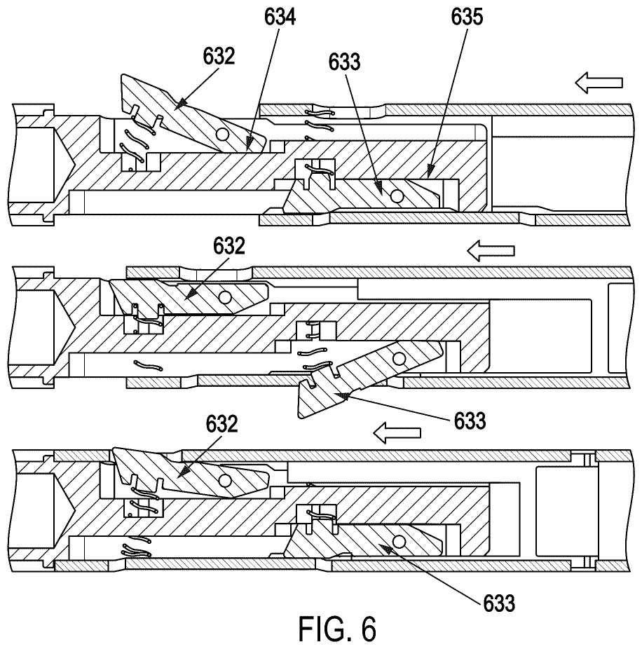

FIG. 6 is a schematic diagram of an interlocking system for modular extension poles, in different positions of an extension pole. The pole-coupling mechanism incorporates offset barbs 632 and 633, preventing the pole from falling through the pole mount into the tank even of adjacent poles are not properly coupled. A barb-opening limiting surface 634 ensures that the barb 632 does not over-rotate if it is required to resist the pulling force of the system. Likewise, a barb-opening limiting surface 635 ensures that the barb 633 does not over-rotate if it is required to resist the pulling force of the system.

FIG. 7A is a schematic diagram of a system for extension-pole control device passthrough protection. FIG. 7A depicts barbs 732 and 733, a ferrule 736, and a ferrule alignment tube 737. The barb 732 functions as the primary barb, while the barb 733 functions as a secondary attachment barb to catch the pole from falling if the primary barb fails. The ferrule 736 is the main mechanical coupling between the two poles. The ferrule alignment tube 737 ensures alignment of the barbs and slots.

FIG. 7B is another schematic diagram of the system in FIG. 7A for extension-pole control device passthrough protection. FIG. 7B depicts barbs 732 and 733, and barb springs 738. The barb springs 738 push the barbs 732/733 out into position to ensure locking with the mating pole automatically.

FIG. 7C is another schematic diagram of the system in FIG. 7A for extension-pole control device passthrough protection, shown along with the extension-pole control device 720. FIG. 7C depicts barbs 732 and 733, a pole feed collapsible handle 721, and a barb holding surface 739.

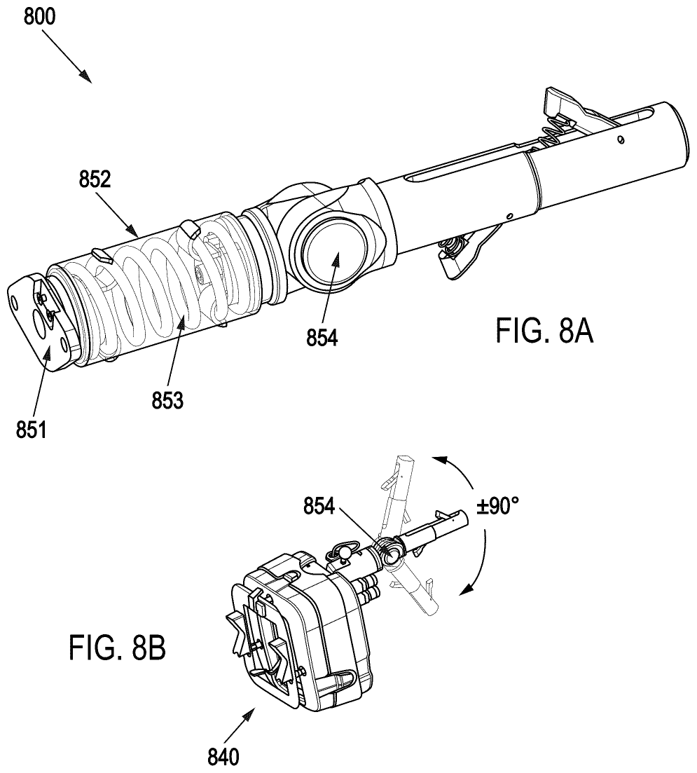

FIG. 8A is a schematic diagram of a test-tool position-compensation sub-system 800, including a mount 851, a sewn cover 852, a spring 853, and a button 854. The mount 851 is a simple screwed-in mount to connect the other components of the test tool (e.g., the surface-contact-sensing sub-system). The spring 853 allows for conforming to various surfaces. In particular, an extension-pole control device that is spring-based and uses a pivot point allows the test tool to better conform to an internal vessel wall. The sewn cover 852 provides protection from pinch points of the spring 853 and is strong enough to hold the test tool to retrieve it if the spring 853 breaks. The button 854 allows the joint to rotatably move ±90° (total span of) 180°.

FIG. 8B is a schematic diagram of a system comprising a test tool 840. The button 854 allows the joint to rotatably move ±90° (total span of) 180°. In FIG. 8B, the mount, sewn cover, and spring are hidden from view (see FIG. 8A).

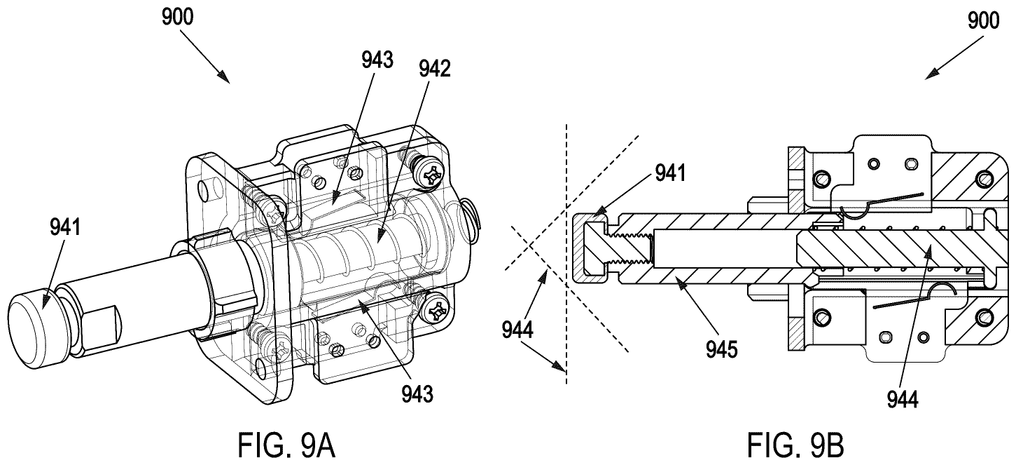

FIG. 9A is a schematic diagram of a surface-contact-sensing sub-system 900. The surface-contact-sensing sub-system 900 includes a plunger tip 941 and a spring 942. The plunger tip 941 is a replaceable, high-friction non-marking plunger tip for gripping the tank walls. The spring 942 provides the plunger extension force. There are two points of contact 943 of sensing per seating device. The first point of contact signals surface contact, while the second point of contact ensures that the test tool plane is at the correct position.

FIG. 9B is another schematic diagram of the surface-contact-sensing sub-system 900 shown in FIG. 9A. An internal sliding surface 944 along with an external sliding surface 945 allow for smooth operations at a variety of surface contact angles. A replaceable, high-friction non-marking plunger tip 921 is used for gripping the equipment walls. During operation, the plunger tip 921 contacts the equipment walls in various patterns or geometries, such as perpendicular, positive, and negative surface contact planes 944.

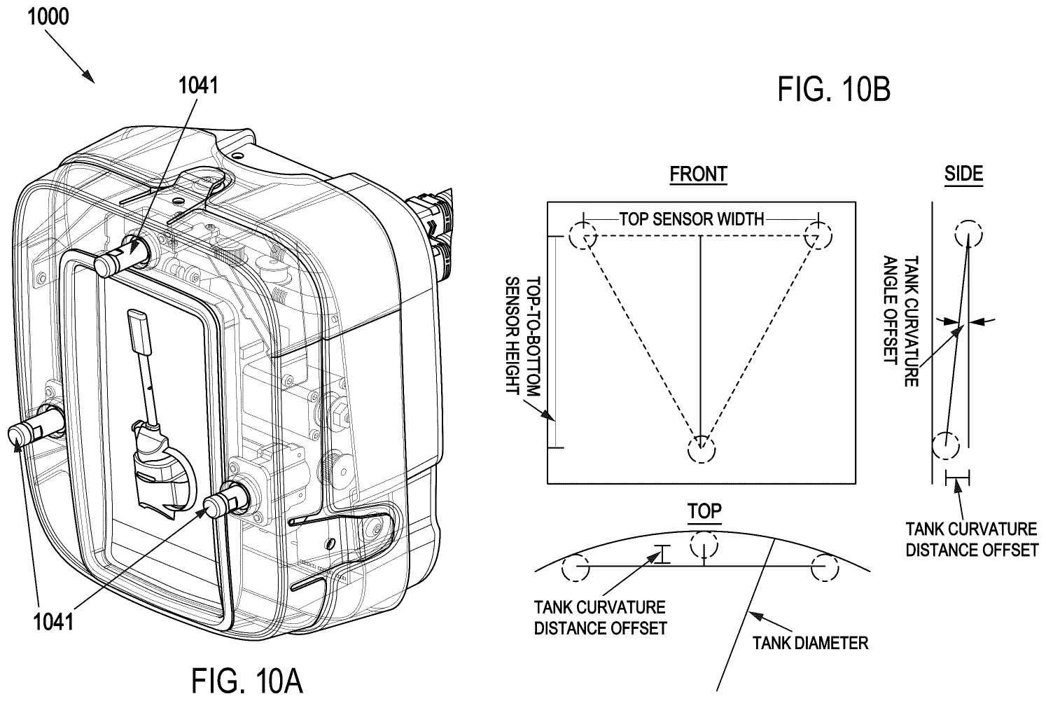

FIG. 10A is a schematic diagram of a surface-contact-sensing sub-system 1000. There are three points of contact 1041, which is desirable for confirming surface detection and swabbing distance which translates into swabbing pressure, for example. The points of contact 1041 are created by distinct plungers.

FIG. 10B depicts the surface contact seating geometry achieved with the surface-contact-sensing sub-system 1000 of FIG. 10A. The three points of contact 1041 (see FIG. 10A) form triangle positions that are mathematically determined to ensure minimal variation of swabbing pressure between tanks of various curvatures. Tank curvature angle offset as well as tank curvature distance offset are geometrically considered. Note that the triangle in FIG. 10B can point up or point down.

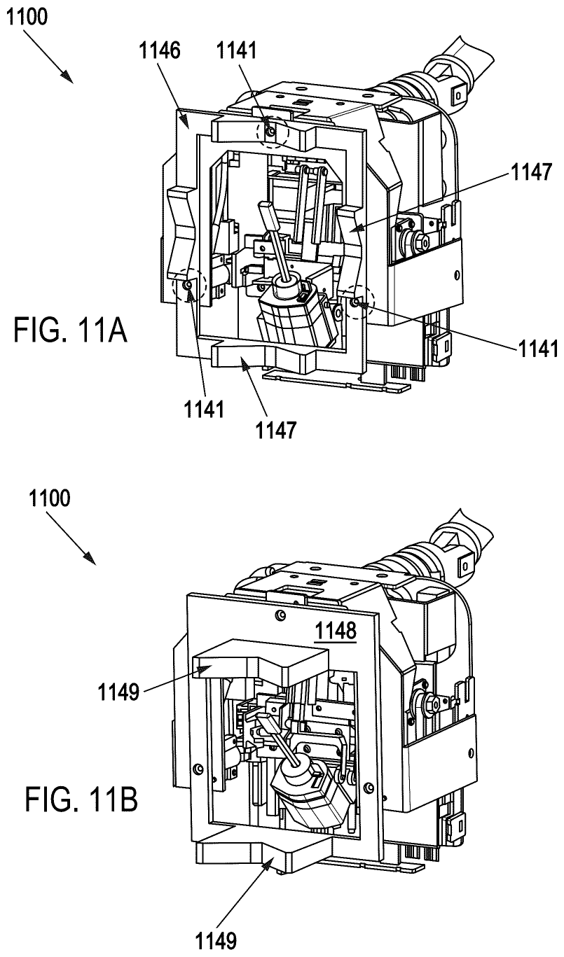

FIG. 11A is a schematic diagram of a surface-contact-sensing sub-system 1100. Three points of contact 1141 form triangle positions that are mathematically determined to ensure minimal variation of swabbing pressure between tanks of various curvatures. Horizontal and vertical centering bosses 1147 are utilized (FIG. 11A depict two horizontal centering bosses and two vertical centering bosses). A convex swabbing faceplate 1146 is mounted to the plungers.

FIG. 11B is another schematic diagram of the surface-contact-sensing sub-system 1100 shown in FIG. 11A. Three points of contact 1141 form triangle positions that are mathematically determined to ensure minimal variation of swabbing pressure between tanks of various curvatures. The surface-contact-sensing sub-system 1100 includes a shaft-coupling faceplate 1148 and large centering bosses 1149 (different from the centering bosses 1147 in FIG. 11A).

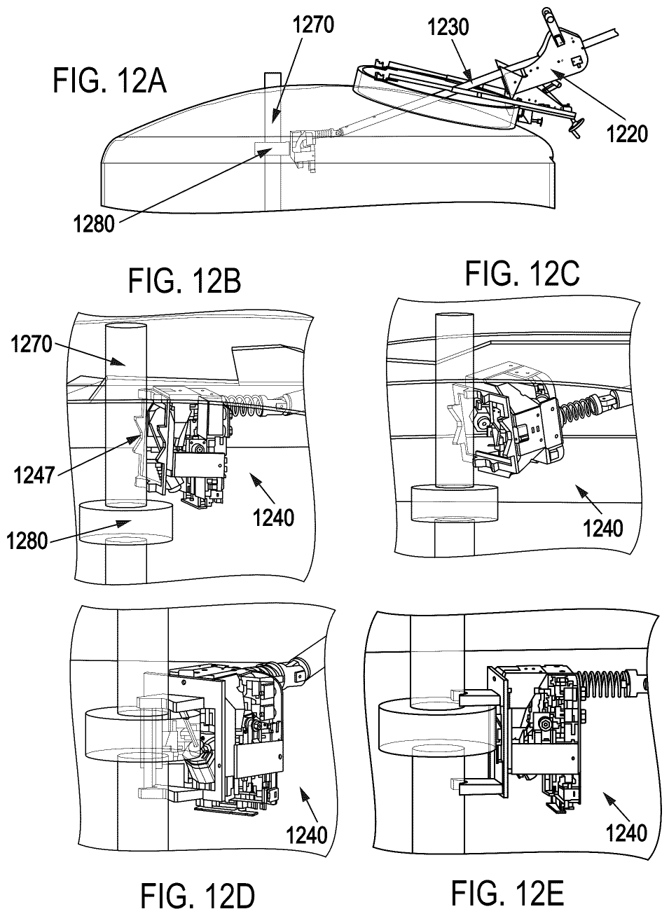

FIG. 12A depicts the inspection of a shaft coupling 1280 that couples sections of an agitator shaft 1270, using a test tool 1240. The modular extension poles 1230 and the extension-pole control device 1220 are shown in this diagram.

FIG. 12B depicts the inspection of an agitator shaft 1270 using the test tool 1240 in a vertical configuration. The centering bosses 1247 are used to assist in the inspection of the agitator shaft 1270. In this diagram, the shaft coupling 1280 is not being inspected.

FIG. 12C depicts the inspection of an agitator shaft 1270 using the test tool 1240 in a horizontal configuration. The centering bosses 1247 are used to assist in the inspection of the agitator shaft 1270. In this diagram, the shaft coupling 1280 is not being inspected.

FIG. 12D depicts the inspection of a shaft coupling 1280 using the test tool 1240 in a vertical configuration. The large centering bosses 1249 are used to assist in the inspection of the shaft coupling 1280. In this diagram, the agitator shaft 1270 is not being inspected.

FIG. 12E depicts the inspection of a shaft coupling 1280 using the test tool 1240 in a vertical configuration. The large centering bosses 1249 are used to assist in the inspection of the shaft coupling 1280. In this diagram, the agitator shaft 1270 is not being inspected.

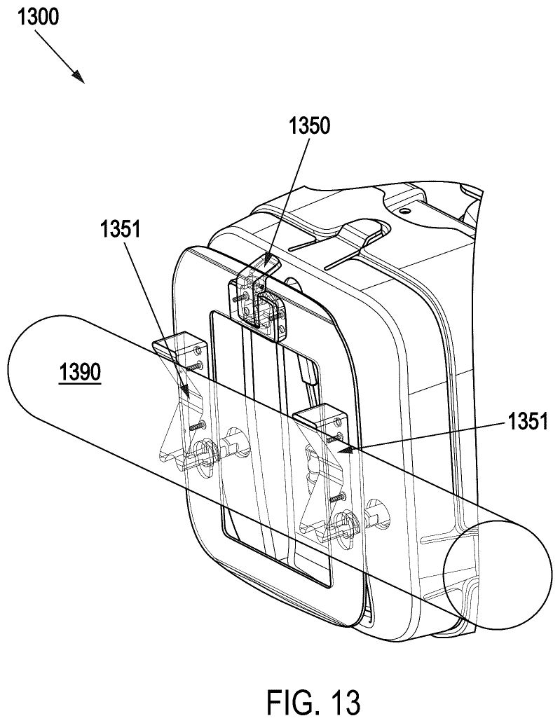

FIG. 13 is a schematic diagram of a surface-contact-sensing sub-system 1300, in which a cylinder 1390 is being inspected/tested. The surface-contact-sensing sub-system 1300 includes a quick-release clip 1350, and V-blocks 1351. The quick-release clip 1350 allows simple removal and installation around removable plunger tips while leaving them in place. The V-blocks 1351 align cylindrical surfaces correctly to ensure that the predefined scanning pattern applies accurate pressure and covers the appropriate area. The V-blocks 1351 allow for small-diameter and large-diameter cylinders to be aligned within a given range.

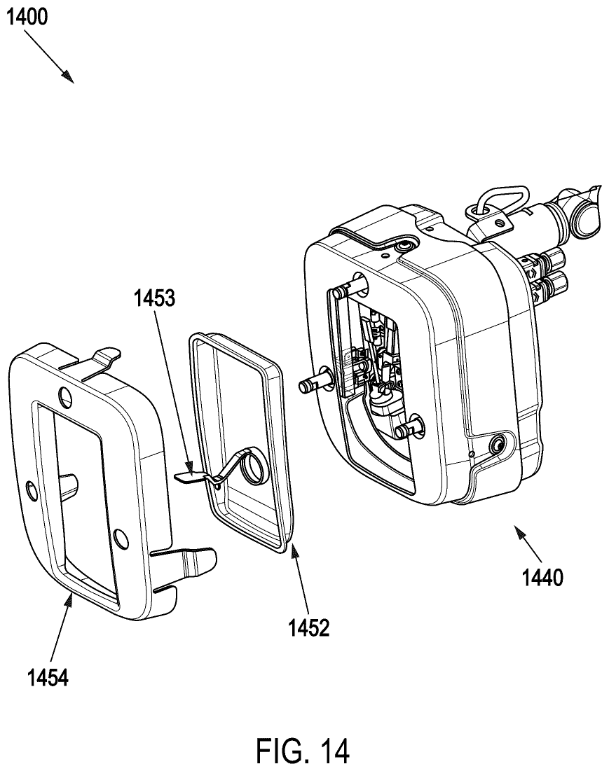

FIG. 14 is a schematic diagram of a test tool sub-system 1400 with a protective flexible cover and optional swab protector. The test tool 1440 is configured with a stretchable membrane 1452, an optional swab protector 1453, and a membrane holder 1454. The stretchable membrane 1452 is a low-force membrane allowing low-cost, low-force stepper motors to move in their full x-y travel without limiting their movement due to force restrictions in a constrained linear length of membrane. The swab protector 1453 is bonded to the low-force membrane and snaps around the swab holder. The swab protector 1453 provides protection from the swab head from contacting the membrane when the swab is in the retracted position. The optional swab protector 1453 also connects the stretchable membrane 1452 to the test tool. The stretchable membrane 1452 is snapped onto the membrane holder 1454 and then secured to the front housing of the test tool to clamp the stretchable membrane 1452 and ensure it stays in place during operation. This configuration also makes it convenient to replace the stretchable membrane 1452 as needed (e.g., due to mechanical damage or contamination).

The equipment-inspection navigation device may be manual, automatic, or a combination thereof. A fully automated equipment-inspection navigation device may include (1) a vision system that maps the interior surfaces of the equipment; (2) a control system that drives electric motors used to move the testing tool(s) to and from the desired locations as identified by the vision system; (3) a software application that collects and analyzes the test data; and (4) an automated tool with automated loading of consumables.

As noted earlier, the equipment-inspection navigation device may be configured with six degrees of freedom. The first degree of freedom is provided by the equipment mount base, which can be positioned around the access port and pivot once attached to the equipment. This freedom is important because it gives the operator access to all parts of the equipment. Second and third degrees of freedom are provided by the extension-pole control device, which can change the angle of the modular extension poles with respect to the access port, and increase or decrease the length of the modular extension poles positioned within the equipment. These two degrees of freedom work together to allow the operator to guide the test tool to the desired location within the selected equipment. The fourth degree of freedom is also provided by the extension-pole control device, which allows for the rotation of the modular extension poles to ensure that the test tool is in the proper orientation with respect to the surface to be tested. The fifth and sixth degrees of freedom are provided by the test-tool position-compensation sub-system, which allows the testing tool to change its angle—in all directions—with respect to the modular extension poles. These two degrees of freedom are important to allow the test tool to be effectively positioned against essentially any surface within the selected equipment.

It can be important to be able to test difficult-to-access surfaces within a vessel. Depending on the application, the specific areas to be tested may be chosen based on known contamination points (e.g., agitators, agitator shafts, input/output ports, etc.), mathematical optimization algorithms, prescribed testing protocols, computational fluid-dynamics simulation to reveal areas not easily exposed to cleaning fluid, or randomly, for example. In some cases, just one equipment surface needs to be tested at a given time. That same surface might be tested at later times (e.g., in distinct production runs) to be able to compare to previous results. In other cases, it can be desirable to test many internal surfaces within the selected equipment. In the extreme, it might be useful to test essentially all internal surfaces within the selected equipment, such as for corrosion or mechanical fatigue testing.

In some embodiments, the equipment-inspection navigation device is capable of accessing at least 50% of the surface area defined by all internal surfaces within a selected equipment. In preferred embodiments employing six degrees of freedom, as described in the preceding paragraph, the equipment-inspection navigation device is capable of accessing at least 75% of the surface area defined by all internal surfaces within a selected equipment, more preferably at least 90% of such surface area, even more preferably at least 95% of such surface area, and most preferably at least 99% of such surface area (and potentially 100% of such surface area).

The equipment-inspection navigation device is typically employed when the selected equipment is substantially empty of normal chemical contents. For example, when the vessel is a bioreactor producing a pharmaceutical compound from sugar fermentation utilizing bacteria, following the production campaign, it can be imperative that the bioreactor is cleaned of the bacteria so that a different product may be produced in the next production. In this case, typically the bioreactor will be emptied and may be steam-cleaned and potentially sterilized with a sterilization agent, such as sodium hypochlorite. Following such cleaning, the equipment-inspection navigation device may be used to test one or more internal surfaces to ensure no bacterial contamination.

There are, however, other use cases. It is possible that the equipment-inspection navigation device is used within equipment that still contains reaction contents. For example, when the vessel is a bioreactor producing a pharmaceutical compound from sugar fermentation utilizing yeast, in which bacteria is a contaminant, the production may be stopped for a relatively short period of time, for testing. The bioreactor manway may be opened and the equipment-inspection navigation device used to test a bioreactor wall for the presence of the contaminating bacteria. Optionally, a sample of the liquid broth may be collected using conventional means as well, although it should be noted that bacteria can sometimes hide more effectively at the walls, compared to the liquid bulk phase—especially for walls having high surface roughness.

In this detailed description, reference has been made to multiple embodiments and to the accompanying drawings in which are shown by way of illustration specific exemplary embodiments of the invention. These embodiments are described in sufficient detail to enable those skilled in the art to practice the invention, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the invention. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein. This specification incorporates by reference U.S. Pat. No. 10,576,511, issued on Mar. 3, 2020.

The embodiments, variations, and figures described above should provide an indication of the utility and versatility of the present invention. Other embodiments that do not provide all of the features and advantages set forth herein may also be utilized, without departing from the spirit and scope of the present invention. Such modifications and variations are considered to be within the scope of the invention defined by the claims.

What is claimed is:

1. An equipment-inspection navigation device comprising:
an equipment mount base configured to attach to an access port of a selected inspectable equipment;
an extension-pole control device connected to said equipment mount base;
one or more modular extension poles connected to said extension-pole control device;
a test tool connected to at least one of said modular extension poles;
a test-tool position-compensation sub-system connected to said modular extension poles; and
a surface-contact-sensing sub-system connected to said test-tool position-compensation sub-system.

2. The equipment-inspection navigation device of claim 1, wherein said equipment mount base is configured to rotate around said access port of said selected inspectable equipment.

3. The equipment-inspection navigation device of claim 1, wherein said extension-pole control device provides three degrees of freedom to move said test tool within said selected inspectable equipment.

4. The equipment-inspection navigation device of claim 1, wherein said extension-pole control device comprises auto-locking independent crank handles.

5. The equipment-inspection navigation device of claim 1, wherein said modular extension poles utilize interlocking barbs.

6. The equipment-inspection navigation device of claim 1, wherein said test-tool position-compensation sub-system provides two degrees of freedom for said test tool relative to said modular extension poles.

7. The equipment-inspection navigation device of claim 1, wherein said surface-contact-sensing sub-system comprises a sensor that provides feedback on initial contact of said test tool with an interior surface of said selected inspectable equipment.

8. The equipment-inspection navigation device of claim 1, wherein said surface-contact-sensing sub-system comprises a sensor that provides feedback on distance of said test tool from an interior surface of said selected inspectable equipment.

9. The equipment-inspection navigation device of claim 1, wherein said test tool contains a swab.

10. The equipment-inspection navigation device of claim 1, wherein said test tool is configured to measure or detect bacteria.

11. The equipment-inspection navigation device of claim 1, wherein said test tool is configured to measure surface thickness and/or surface roughness.

12. The equipment-inspection navigation device of claim 1, wherein said test tool is configured to record photographic data comprising photographic images and/or video.

13. The equipment-inspection navigation device of claim 12, wherein said test tool contains a swab configured to contact interior surfaces of said selected inspectable equipment, and wherein said test tool is configured to utilize said photographic data, as an input, to assist in directing placement of said swab, as an output.

14. The equipment-inspection navigation device of claim 1, wherein a control sub-system is configured to drive electric motors to move said test tool to a desired location.

15. The equipment-inspection navigation device of claim 1, wherein said equipment-inspection navigation device is configured with six degrees of freedom.

16. An equipment-inspection navigation device comprising:
an extension pole configured for insertion into an inspectable equipment, said extension pole having a first end portion and a second end portion;
a pole-mounting system coupled to said first end portion of said extension pole, wherein said pole-mounting system is configured to attach to an accessible region of said inspectable equipment that is accessible from a space outside said inspectable equipment; and
an automated swab device coupled to said second end portion of said extension pole, wherein said automated swab device is configured to execute a swabbing process on an interior surface of said inspectable equipment,
wherein said automated swab device is connected to said extension pole via a locking joint and a spring unit,
wherein said locking joint is adjustable and configured to allow for a plurality of different angular orientations of said automated swab device in relation to said extension pole, and
wherein said spring unit is flexible and configured to allow for a plurality of different positions of said automated swab device in relation to said interior surface of the inspectable equipment.

17. The equipment-inspection navigation device of claim 16, wherein said pole-mounting system includes a mount base and an extension-pole control device coupled to said mount base, wherein said pole-mounting system is configured to attach to said accessible region via said mount base, and wherein said pole-mounting system is coupled to said first end portion of said extension pole via said extension-pole control device.

18. An equipment-inspection navigation device comprising:
a pole-mounting system configured to attach to an accessible region of said inspectable equipment that is accessible from a space outside said inspectable equipment;
an extension pole configured for insertion into said inspectable equipment, wherein said extension pole includes a plurality of pole segments; and
a set of barbs connected to said extension pole,
wherein said plurality of pole segments are detachably coupled to one another via said set of barbs, wherein each barb within said set of barbs is configured with an independent lock mechanism, and
wherein said pole-mounting system includes an extension-pole control device detachably coupled to at least one pole segment from said plurality of pole segments.

19. The equipment-inspection navigation device of claim 18, wherein at least one pole segment from said plurality of pole segments is extendable from a first segment length to a second segment length, and wherein said set of barbs are configured to prevent said plurality of pole segments from extending beyond a stop length associated with said extension pole.

20. A method of inspecting equipment, said method comprising:
(a) selecting an inspectable equipment to be inspected;
(b) providing an equipment-inspection navigation device, wherein said equipment-inspection navigation device comprises an equipment mount base configured to attach to an access port of a selected inspectable equipment; an extension-pole control device connected to said equipment mount base; one or more modular extension poles connected to said extension-pole control device; a test tool connected to at least one of said modular extension poles; a test-tool position-compensation sub-system connected to said modular extension poles; and a surface-contact-sensing sub-system connected to said test-tool position-compensation sub-system;
(c) attaching said equipment mount base to said access port of said inspectable equipment;
(d) navigating said test tool to a desired interior surface of said inspectable equipment using said extension-pole control device and said modular extension poles;
(e) positioning said test tool against a desired interior surface using said test-tool position-compensation sub-system and said surface-contact-sensing sub-system; and
(f) performing an inspection using said test tool,
wherein said inspection is optionally selected from the group consisting of surface swabbing for cleaning validation, surface swabbing for equipment monitoring, bacteria contact plate sampling for cleaning validation, bacteria contact plate sampling for equipment monitoring, surface-thickness measurement, surface-roughness measurement, and combinations thereof, and
wherein optionally steps (d), (e), and (f) are automated.
